(19) United States
(12) Patent Application Publication
(10) Pub. No.: US 2026/0303914 A1
(43) Pub. Date: Oct. 1, 2026

(54) DYNAMIC TITLE AND THUMBNAIL MODIFICATION OF PARTIALLY VIEWED VIDEO CONTENT

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN); NAKUL PATEL, NAGPUR (IN)

(21) Appl. No.: 19/095,147

(22) Filed: Mar. 31, 2025

(51) Int. Cl. H04N 21/472; H04N 21/482

(52) U.S. Cl. CPC H04N 21/47217; H04N 21/482

(57) ABSTRACT

A method provides techniques for dynamic video title and thumbnail generation. A partially viewed video is identified, where the video is represented by a corresponding first title and first thumbnail. Unviewed segments of the video are identified, and are ranked based on a potential interest level, where the potential interest level is based on at least one of viewer retention analytics for the video, and content uniqueness of the video. A second title is generated based on a highest-ranked unviewed segment from the unviewed segments. An image is identified from within the unviewed segments corresponding to the highest-ranked unviewed segment. A second thumbnail is created based on the image. The first title and/or first thumbnail is replaced with a corresponding second title and/or second thumbnail. The listing of the video is rendered and presented using the at least one of the second title and the second thumbnail.

### BACKGROUND

### 1. Technical Field

The present disclosure generally relates to electronic devices, and more specifically to electronic devices that have video display capabilities.

### 2. Description of the Related Art

Online video streaming and video consumption platforms such as Netflix® and YouTube® have become a most popular way for people to consume content, with billions of users watching videos every day. These platforms offer a vast range of content, from entertainment and education to news and tutorials, making them a primary source of information and engagement for users worldwide. While short-form videos have gained popularity with the rise of platforms such as TikTok and YouTube Shorts, long-form videos (e.g., those over two minutes in length) remain essential for in-depth exploration of various topics. These longer videos allow content creators to dive deeper into discussions, tutorials, documentaries, and storytelling, providing audiences with a more comprehensive understanding of a subject.

Viewer engagement plays an important role in the content creation ecosystem, as it directly impacts the platform's algorithms and monetization models. Platforms like YouTube analyze key engagement metrics, such as watch time, likes, comments, and shares, in order to determine how well a video performs. This data influences whether a video is recommended to other users, which in turn affects a creator's reach and revenue potential.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2A illustrates an example user interface showing multiple unwatched videos in a video listing, according to one or more embodiments;

FIG. 2B continues the example from FIG. 2A, showing the videos in a partially watched state with dynamically updatable thumbnails and titles, according to one or more embodiments;

FIG. 2C continues the example from FIG. 2B, showing a first video in a partially watched state with additional viewing progress and presenting a dynamically updated thumbnail and title, according to one or more embodiments;

FIG. 2D continues the example from FIG. 2C, showing a second video in a partially watched state with additional viewing progress and indicating a dynamically updated thumbnail and title based on user profile data for a user associated with the electronic device, according to one or more embodiments;

FIG. 3 illustrates an example of a representation of data used for implementing features of dynamic thumbnail and/or title modification, according to one or more embodiments;

FIG. 4 illustrates an example of a surfaced notification indicating an updated dynamic thumbnail and/or title modification, according to one or more embodiments;

FIG. 5 depicts a flowchart of a computer-implemented method for dynamic thumbnail and/or title modification on an electronic device, according to one or more embodiments; and FIG. 6 depicts a flowchart of a computer-implemented method for additional embodiments for implementing dynamic thumbnail and/or title modification on an electronic device, according to one or more embodiments.

### DETAILED DESCRIPTION

According to aspects of the present disclosure, an electronic device, a method, and a computer program product provide techniques for performing dynamic thumbnail and title modification for partially viewed video content. When a user starts watching a video, the user's progress is tracked. If the user stops watching the video prior to reaching the end of the video, the video can be considered to be partially viewed. Unwatched sections or chapters of the video are analyzed, and a new thumbnail and/or title of the video can be generated dynamically, based at least in part on the unviewed content within the partially viewed video. The dynamically generated thumbnail and/or title can replace the original thumbnail and/or title. In this way, when the partially viewed video appears in the user's video listing at a future time, the viewer is presented with the updated thumbnail and/or title that may encourage the user to continue viewing the partially viewed video. One or more embodiments may further provide a notification of the updated thumbnail and/or title to encourage the user to return to the video platform to continue viewing the partially viewed video.

When a user watches only a portion of a video, such as the first few minutes of a 15-minute video, the features of disclosed embodiments can adjust the displayed thumbnail and/or title when the video reappears in the user's listing. Instead of showing the original title and thumbnail, which might not be as effective in re-engaging the user, disclosed embodiments can highlight unviewed sections or upcoming key moments. This personalized approach can reignite the user's interest by emphasizing the most relevant or intriguing aspects that the user/viewer has yet to experience, increasing the likelihood that they will continue watching rather than scrolling past the video.

For content creators, disclosed embodiments can provide a major advantage in maximizing watch time, which is an important factor in platform algorithms that determine video rankings, recommendations, sand monetization. By dynamically adapting the way the video content identifiers are presented based on a user's previous progress through the video, creators can retain more viewers throughout the entirety of their videos, leading to higher engagement rates, increased advertising revenue, and a greater chance of receiving likes, comments, and shares. Additionally, disclosed embodiments can help to optimize content discovery by ensuring that partially viewed videos do not become lost in a sea of new content, but instead remain relevant and appealing to users, fostering stronger connections between the video and the consumers.

One or more embodiments can provide an electronic device that includes: at least one display; a memory having stored thereon a dynamic thumbnail modification (DTM) module; and at least one processor communicatively coupled to the at least one display and the memory. The at least one processor executes program code of the DTM module and is configured to cause the electronic device to: identify that a video is a partially viewed video, wherein the video is represented by a corresponding first title and first thumbnail; identify one or more unviewed segments of the video; rank the one or more unviewed segments based on a potential interest level, wherein the potential interest level is based on at least one of viewer retention analytics for the video and content uniqueness of the video; generate a second title based on a highest-ranked unviewed segment from the one or more unviewed segments; identify an image from within the one or more unviewed segments corresponding to the highest-ranked unviewed segment; create a second thumbnail based on the image; replace at least one of the first title with the second title and the first thumbnail with the second thumbnail; and render and present, on the at least one display, an updated listing of the video using the at least one of the second title and the second thumbnail.

One or more embodiments can provide a method that includes: identifying, by at least one processor of an electronic device that includes at least one display, a video that is a partially viewed video, wherein the video is represented by a corresponding first title and first thumbnail; identifying one or more unviewed segments of the video; ranking the one or more unviewed segments based on a potential interest level, wherein the potential interest level is based on at least one of viewer retention analytics for the video, and content uniqueness of the video; generating a second title based on a highest-ranked unviewed segment from the one or more unviewed segments; identifying an image from within the one or more unviewed segments corresponding to the highest-ranked unviewed segment; creating a second thumbnail based on the image; replacing at least one of the first title with the second title and the first thumbnail with the second thumbnail; and rendering and presenting, on the at least one display, an updated listing of the video using the at least one of the second title and the second thumbnail.

Further embodiments can provide a computer program product including: a non-transitory computer readable medium; and program code on the computer readable medium that when processed by a processor of an electronic device configures the processor to perform functions of the above-described method.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, “some embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

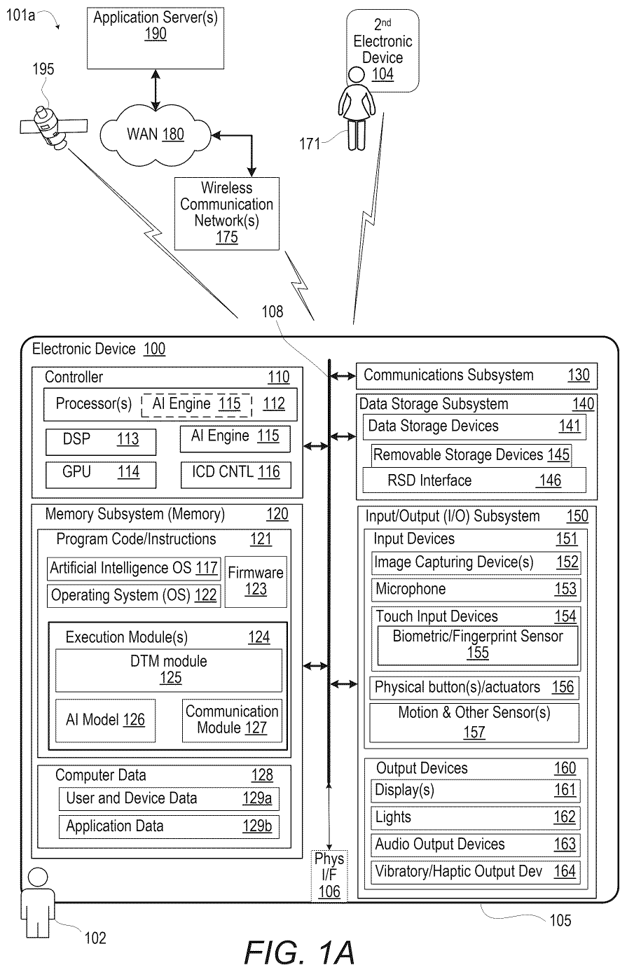

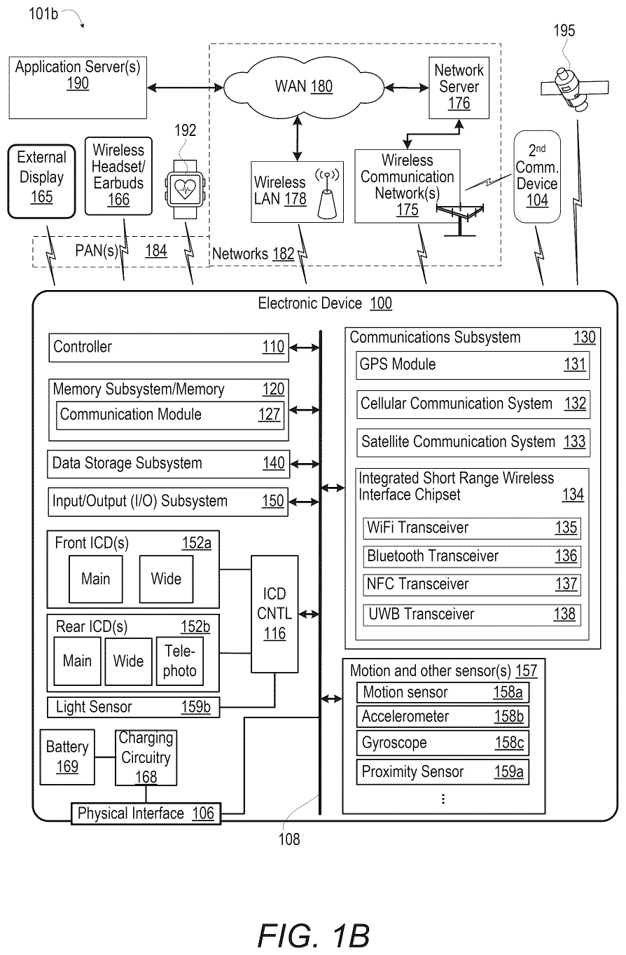

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments.

Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of this disclosure, electronic device 100 is assumed to be a communication device that can be used to engage in a voice and/or video call with a second communication device. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122. Operating system 122 may include or be augmented by device AI operating system (OS) 117 that can include native support for AI-specific hardware such as Neural Processing Units (NPUs) or Tensor Processing Units (TPUs) to optimize performance for AI tasks such as machine learning inference and training.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, dynamic thumbnail and title modification (DTM) module 125, which provides the features and operating functionality of the disclosed embodiments when the corresponding program instructions of DTM module 125 are processed by/within processor 112/controller 110.

Execution modules 124 further includes AI model(s) 126. In one or more embodiments, processor 112 can utilize AI models 126 to provide AI functionality of processor-integrated AI engine 115. In other embodiments, AI models 126 are directly utilized by AI engine 115. In one or more embodiments, AI model(s) 126 is integrated as a sub-module within DTM module 125 and is trained to support AI features of DTM module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, DTM module 125 can include program instructions that cause or configure processor 112 to cause electronic device 100 to dynamically generate, render, and present new thumbnails and/or titles for partially viewed videos. Other features provided by DTM module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of DTM module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by a user to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which follows.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive a user's tactile/touch input. As a touch screen device, integrated display 161 allows a user to provide input to and/or to control electronic device 100 by touching features within a user interface presented on integrated display 161. Tactile, touch input device 154 can include a touch screen interface. The touch screen interface can include one or more virtual buttons or selectable affordances. In one or more embodiments, when user 102 applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device 100 to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem 130 includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRx) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 171 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of DTM module 125 and/or access to other applications, online transactions, and resources. In one or more embodiments, networks 182 can also include personal area networks (PAN) 184, which are individually created with second devices via one of short-range wireless devices from among Wi-Fi TxRx 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image and/or iris scan recognition.

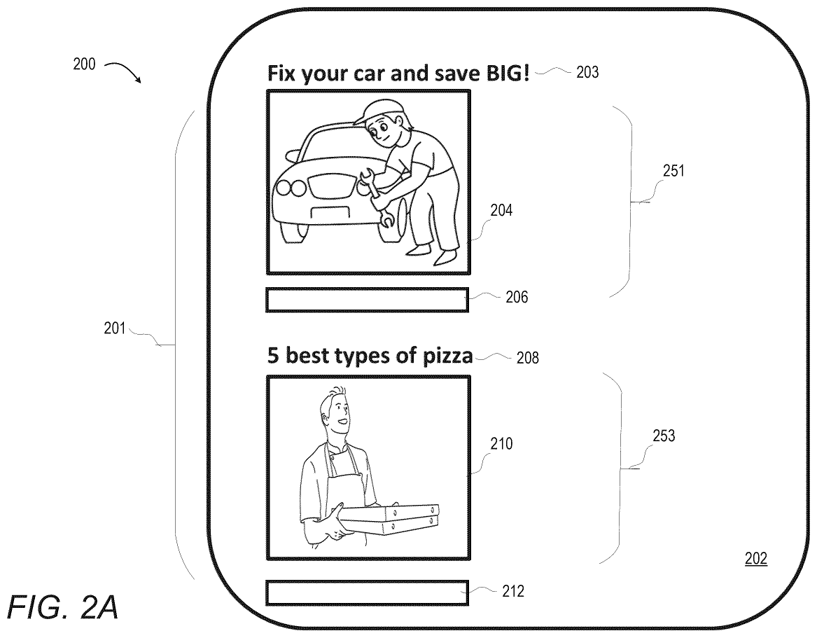

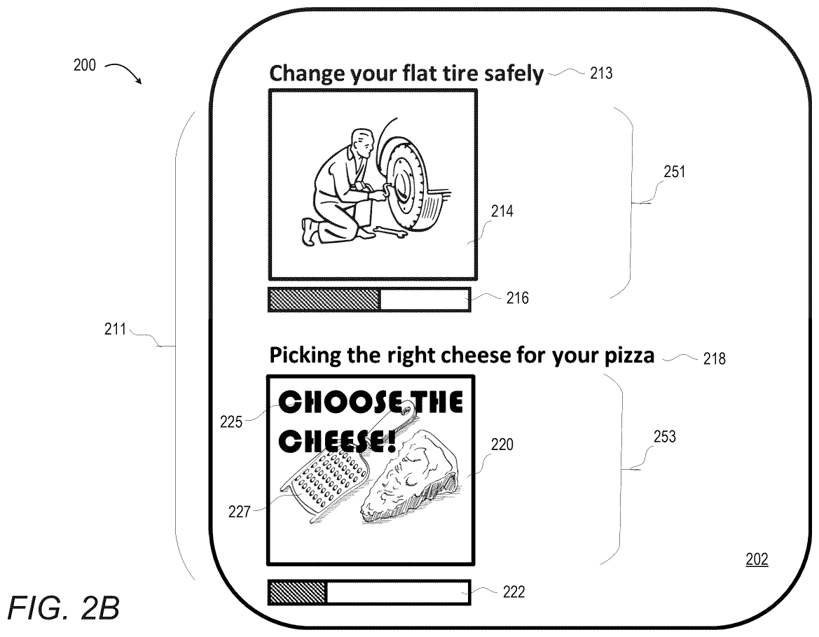

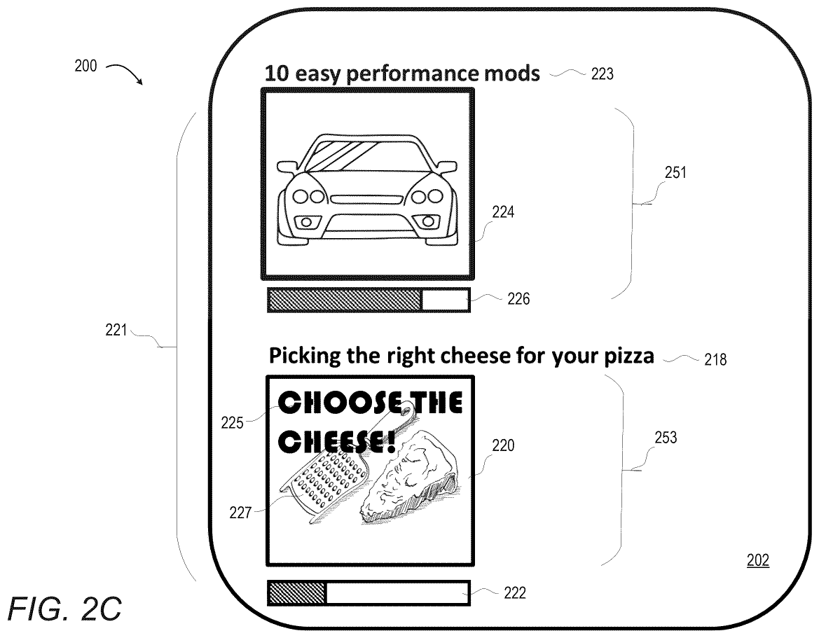

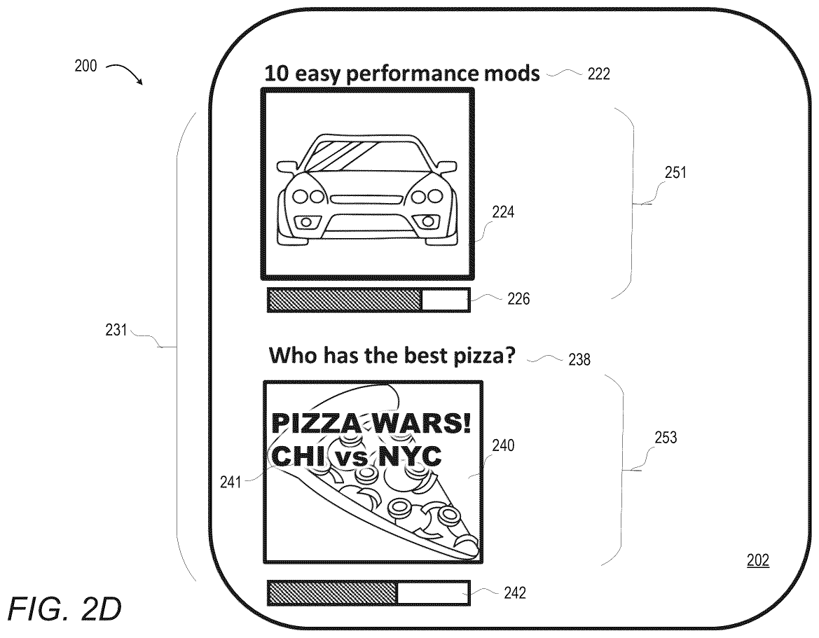

FIG. 2A illustrates an example user interface showing multiple unwatched videos in a video listing, according to one or more embodiments. FIG. 2A shows an electronic device 200, which, in one or more embodiments, may be similar to electronic device 100 shown in FIG. 1A and FIG. 1B. Electronic device 200 includes display 202. Rendered and presented on display 202 is a video listing 201. The video listing 201 provides a list of videos that are presented as available to view on a video platform, such as YouTube, or other video platform. Video platforms may use a variety of factors to determine which videos appear in a user's listing, aiming to maximize engagement and provide personalized content recommendations. One technique can include analyzing a user's viewing history. If a user frequently watches videos on a particular topic, such as automobiles, technology, or fitness, the platform's algorithm is likely to prioritize similar content. This can include newly uploaded videos on the same subject, videos from creators the user has previously engaged with, and/or videos with similar themes, keywords, or viewer demographics. The algorithm for creating the video listing may also take into account watch time, meaning if a user fully watches certain types of videos but quickly skips others, the algorithm may adjust recommendations accordingly to surface content that aligns with the user's preferences.

Beyond viewing history, user profile details, such as age, gender, location, and/or language settings can be used as criteria for the creation of dynamic titles and/or thumbnails of partially viewed videos for presentation in a video listing. For example, a user in a particular country may be more likely to engage in content that is indicated by a thumbnail and/or title that aligns with local interests and cultural relevance. Additionally, engagement patterns, such as likes, comments, and subscriptions, help refine the generation of dynamic titles and/or thumbnails, and encouraging users to continue watching the partially viewed videos.

Referring again to FIG. 2A, two video assets are shown within video listing 201. A first video asset 251 is shown, having original title 203, original thumbnail 204, and progress indicator 206. As shown in FIG. 2A, progress indicator 206 indicates that first video asset 251 is unviewed. Similarly, a second video asset 253 is shown, having original title 208, original thumbnail 210, and progress indicator 212. As shown in FIG. 2A, progress indicator 212 indicates that second video asset 253 is also unviewed. As indicated by title 203 and thumbnail 204, first video asset 251 pertains to automobiles. The topics contained within video asset 251 can include a section for basic repairs, followed by a section on changing a tire, followed by a section on performance tips for automobiles. Similarly, as indicated by title 208 and thumbnail 210, second video asset 253 pertains to pizza. The topics contained within video asset 253 can include a section that describes different types of pizza, followed by a section focusing specifically on types of cheese that may typically be used for pizza, followed by a section focusing on regional differences in pizza. While two videos are shown in the example of FIG. 2A, in general, video listings may present more than two videos simultaneously. Moreover, user interface actions such as scrolling or swiping can be used to reveal additional videos within a video listing.

FIG. 2B continues the example from FIG. 2A, showing the video listing 211, at some later time from FIG. 2A, indicating first and second video assets 251 and 253 in a partially watched state with dynamically selected thumbnails and titles, according to one or more embodiments. In one or more embodiments, the new thumbnail can be an image frame from the video asset. In one or more embodiments, a new thumbnail may be generated via AI-techniques such as using a Generative Adversarial Network (GAN). As shown in FIG. 2B, progress indicator 216 indicates that first video asset 251 is partially viewed. Accordingly, the title 213 has now been updated as compared with original title 203 of FIG. 2A. Similarly, the thumbnail 214 has been updated as compared with original thumbnail 204 of FIG. 2A. Based on the example content described for video asset 251, if the section of the video asset 251 pertaining to changing a tire has not yet been viewed, the thumbnail and/or title for the video asset can be updated to indicate and/or reflect that unviewed section of the video. In the example of FIG. 2B, the thumbnail 214 shows a tire being changed, while the title 213 indicates a topic of tire changing.

Similarly, as shown in FIG. 2B, progress indicator 222 indicates that video asset 253 is also partially viewed. Accordingly, the title 218 has now been updated as compared with original title 208 of FIG. 2A. Similarly, the thumbnail 220 has been updated as compared with original thumbnail 210 of FIG. 2A. Based on the example content described for video asset 253, if the section of the video asset 253 pertaining to the discussion of cheese has not yet been viewed, the thumbnail and/or title for the video asset can be updated to indicate and/or reflect unviewed sections of the video. In the example of FIG. 2B, the thumbnail 220 shows a cheese grater 227, while the title 218 indicates a topic of cheese selection for pizza. Moreover, a mini description 225 is composited over the thumbnail 220. The mini description 225 can be a short summarization of the title 218. The mini description 225 can serve to drive further engagement and increase the likelihood that a user decides to continue viewing second video asset 253.

The mini description feature for video thumbnails of disclosed embodiments can provide a compelling way to enhance user engagement by providing a concise, visually engaging summary of the video's content directly within the thumbnail. One or more embodiments can leverage Natural Language Processing (NLP), to generate a short, catchy version of the video title that captures its essence in just a few words. In the example of FIG. 2B, the video title 218 of “Picking the right cheese for your pizza” is distilled into the mini description 225 of “Choose the cheese!”, making the video topic more immediate and eye-catching. This mini description is then composited over the thumbnail image using a font and color scheme that ensures readability while complementing the background. This dual-layered approach, including presenting both the full title outside the thumbnail and a more noticeable, embedded summary version superimposed on the thumbnail can serve to create an engaging, high-contrast visual that grabs attention in a crowded video listing. One or more embodiments can include: creating a text string of the mini description; and compositing the text string on the image, wherein the text string is superimposed on the image. One or more embodiments can include using a natural language processing (NLP) process to generate the mini description of the second title.

One or more embodiments may utilize a multi-step process to create the mini description. First, one or more NLP algorithms are used to analyze the full video title 218 and extract a concise, attention-grabbing phrase optimized for quick readability. Next, disclosed embodiments can select an optimal font, size, and color scheme based on the background of the thumbnail to ensure the text of the mini description stands out. Machine learning techniques can be used to assess contrast and legibility to avoid issues such as light text on a bright background. Then, disclosed embodiments can composite the mini description onto the thumbnail in an aesthetically pleasing manner, balancing positioning, visibility, and style. This dynamic approach improves video discoverability by making thumbnails more informative at a glance, increasing the likelihood of clicks and engagement, ultimately benefiting both content creators and viewers. Note that the thumbnails and titles shown in FIG. 2B can be specific to a device and/or account. For example, another device that receives the same video assets in a video listing may show different thumbnails and/or titles when in a similar partially viewed state, in part based on the local algorithms used by the AI engine and the user characteristics and interest, and in part based on the size of the display the video content listing is being viewed on.

FIG. 2C continues the example from FIG. 2B, showing a video in a partially watched state at some later time from that shown in FIG. 2B. FIG. 2B shows video listing 221 with additional viewing progress as indicated by progress indicator 226, as compared with original progress indicator 216 of FIG. 2B. As shown in FIG. 2C, there is updated thumbnail 224 and title 223, which are updated to reflect aspects of another unviewed portion of video asset 251. Thus, a user may watch portions of a video, such as a long form video, over the course of hours, days, or weeks, and each time progress advances, a new thumbnail, title, and/or mini description may be generated, and rendered and presented for that video listed within the video listing.

FIG. 2D continues the example from FIG. 2C, showing a video in a partially watched state with additional viewing progress and indicating a dynamically updated thumbnail and title based on user profile data for a user associated with the electronic device, according to one or more embodiments. As can be seen in video listing 231, additional content of the video asset 253 has been viewed by the user, as indicated by process indicator 242, as compared with progress indicator 222 of FIG. 2C. As indicated in FIG. 2D, an updated thumbnail 240 is shown, as compared with thumbnail 220 shown in FIG. 2C. Moreover, the title 238 is updated to reflect a new unwatched section pertaining to the aforementioned section focusing on regional differences in pizza. Continuing with the example, the section on regional differences can include sections on comparing the pizza between various sets of different cities. As examples, the video asset 253 can include a section that compares the pizza of Los Angeles with the pizza of New Orleans, another section that compares the pizza of Houston with the pizza of Atlanta, and another section that compares the pizza of Chicago with the pizza of New York.

The customizable mini description feature that is based on user data, as enabled by disclosed embodiments, can enhance engagement by tailoring video thumbnails to a viewer's personal interests, demographics, and/or viewing history. By dynamically adjusting the mini description text based on user data, such as location, preferences, and/or behavioral data, disclosed embodiments can highlight the most relevant aspects of a video for each individual user. For example, in a pizza comparison video, a user from Chicago might see a thumbnail with the mini description 241 which shows “Pizza Wars! CHI vs NYC”, whereas for a user from (or currently in) Houston, a mini description such as “Houston vs. Atlanta: Who Wins?” may be generated, rendered, and presented in a video listing. This customization increases the likelihood that a user will engage with the content, as the modified mini description directly appeals to the user's background and interests. Beyond location-based personalization, one or more embodiments may also consider a viewer's past viewing habits, watch time, and/or interactions to further refine the mini description for maximum relevance.

One or more embodiments may analyze user data, leveraging demographic information, viewing history, and/or engagement patterns from a user's profile to determine which aspects of a video may be most appealing to the user. Then, using video metadata and NLP, some embodiments can identify different sections of a video that may be emphasized in the image selected for the thumbnail, the new title, and/or the mini description. For example, in the aforementioned pizza video example, sections covering different city comparisons in the pizza video are tagged and categorized. Based on the user's profile and identified relevant sections, machine learning models can be used to generate a customized mini description that highlights the most relevant topic for that particular user within the video. The selected mini description can then be formatted with optimal font size, color, and placement on the thumbnail using techniques such as contrast analysis and visual design principles to ensure readability. One or more embodiments may further collect test engagement metrics. Embodiments may monitor click-through rates and user engagement to refine the personalization strategy over time, improving accuracy and effectiveness. Thus, with features of disclosed embodiments, video platforms can increase user engagement, drive higher retention rates, and enhance content discovery, and ensure video content is returned to after an initial viewing by the user of only a portion (i.e., less than the total content) of the video. One or more embodiments can include: obtaining data for a user associated with the electronic device; and using the data as a criterion to rank the one or more unviewed segments based on a potential interest level of the user. One or more embodiments can include: obtaining demographics data; and identifying one or more interests corresponding to the user. In embodiments, the demographics data can include age, gender, occupation, income level, education level, and/or other relevant data. The demographics data can be obtained from a user profile stored locally within the video viewing application or on the electronic device, or remotely, such as on a video subscription server, etc.

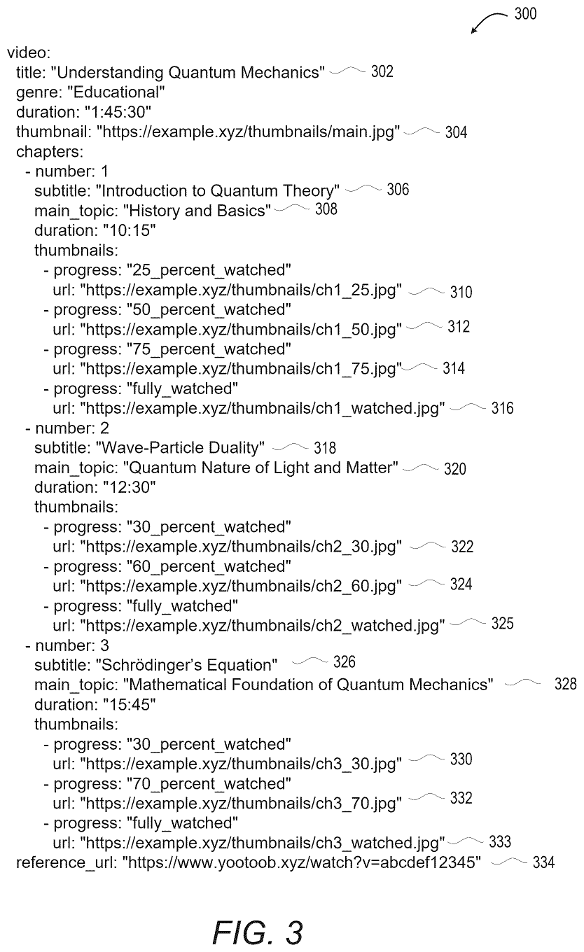

FIG. 3 illustrates an example of a representation 300 of data used for implementing features of dynamic thumbnail and/or title modification, according to one or more embodiments. The representation 300 can be generated by an electronic device, such as electronic device 200 of FIG. 2A. In embodiments, upon loading the video into a video listing, the video asset may be analyzed, and the representation 300 may be generated by, and/or stored on an electronic device (such as electronic device 200 shown in FIG. 2A). Thus, in embodiments, the analysis to determine thumbnails, titles, and/or mini descriptions may be performed before the user actually watches the video. Then, if/when the user decides to watch the video, thumbnails, titles, and/or mini descriptions for various stopping points can be determined a priori, and rendered and presented once the video appears a user's video listing.

As shown in FIG. 3, the representation 300 is in a YAML format. However, one or more embodiments may use another format such as JSON (JavaScript Object Notation), XML (Extensible Markup Language) or a database (e.g., SQL and/or NoSQL), instead of, or in addition to, a YAML format. As further shown in FIG. 3, the data within representation 300 can include a title 302. The data can include a URL (uniform resource locator) identifying a location for default thumbnail for a video asset, indicated at 304. The default thumbnail can be rendered and presented in a video listing when the video is in an unwatched state. In the example of FIG. 3, the video asset has three sections. The data shown in representation 300 can include a subtitle for the first section, indicated at 306, and a topic for the first section, indicated at 308. The data can further include URLs corresponding to thumbnails that can be rendered and presented following different amounts of viewing progress. A thumbnail indicated at 310 is used when the first section is less than 25 percent watched. A thumbnail indicated at 312 is used when the first section is more than 25 percent watched but less than 50 percent watched. A thumbnail indicated at 314 is used for when the first section is more than 50 percent watched but less than 75 percent watched. A thumbnail indicated at 316 is use for when the first section is more than 75 percent watched.

The data shown in representation 300 can include a subtitle for the second section, indicated at 318, and a topic for the first section, indicated at 320. A thumbnail indicated at 322 is used when the second section is less than 30 percent watched. A thumbnail indicated at 324 is used when the second section is more than 30 percent watched but less than 60 percent watched. A thumbnail indicated at 325 is used when the first section is more than 60 percent watched. The data shown in representation 300 can include a subtitle for the third section, indicated at 326, and a topic for the first section, indicated at 328. A thumbnail indicated at 330 is used when the third section is less than 30 percent watched. A thumbnail indicated at 332 is used when the third section is more than 30 percent watched but less than 70 percent watched. A thumbnail indicated at 333 is used when the third section is more than 70 percent watched is indicated at 333. Thus, as illustrated by representation 300, different sections of a long form video can have different numbers of thumbnails and/or titles associated with them. In some embodiments, the thumbnails and titles may be generated during video ingest, and the representation 300 instructs an electronic device as to which thumbnails and/or titles to render and present based on viewer progress. The data may further include a URL for the video asset, indicated at 334. The data shown in representation 300 is exemplary and non-limiting. Other metadata, such as total duration, genre, duration of each section, and viewing progress of the video may also be stored within the representation 300. One or more embodiments may include more, fewer, and/or different metadata than that shown in representation 300.

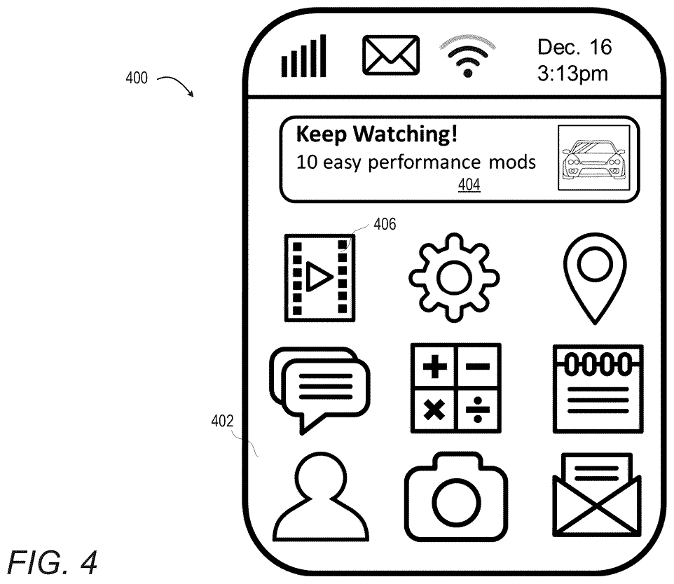

FIG. 4 illustrates an example of a surfaced notification indicating an updated dynamic thumbnail and/or title modification, according to one or more embodiments. FIG. 4 shows an electronic device 400. In one or more embodiments, electronic device 400 may be similar to electronic device 100 shown in FIG. 1A and FIG. 1B. Electronic device 400 includes display 402. Rendered and presented on display 402 is a notification 404. The notification 404 can be surfaced when the electronic device is on a screen such as a home screen, lock screen, or other screen (user interface) outside of the video platform. Upon viewing the notification 404, the user may click/tap the notification to view the partially viewed video from the previous stopping point. Alternatively, the user may press/tap the video platform icon 406 to invoke the video platform application, and/or launch a browser to render and present the video platform. In this way, disclosed embodiments can provide a notification reminder feature for partially viewed videos that can significantly enhance viewer engagement by prompting users to continue watching content they started but did not finish. Many users begin watching a video but get distracted or interrupted, leaving the video unfinished. With features of disclosed embodiments, the platform can periodically send a notification to remind users about their partially watched videos. If the user taps the notification, the video platform app (or a web browser) is launched, allowing the user to seamlessly resume playback from where they left off. This frictionless experience encourages users to complete videos they started watching and have a genuine interested in but might have otherwise forgotten about.

For content creators, the notification features of the disclosed embodiments can translate into higher video watch time and viewer retention rates, which are key metrics in determining video ranking, monetization potential, and platform recommendations. A higher completion rate for a video can lead to better visibility in search results and suggested video listing, ensuring that videos reach a broader audience. Overall, reminder notifications can create a win-win situation, as users can get a more personalized and convenient viewing experience, while content creators can benefit from increased engagement, advertising revenue, and/or potential subscriber growth. One or more embodiments can include rendering and presenting, on the at least one display of the electronic device, a notification indicating a replaced at least one of the title and the thumbnail for the video.

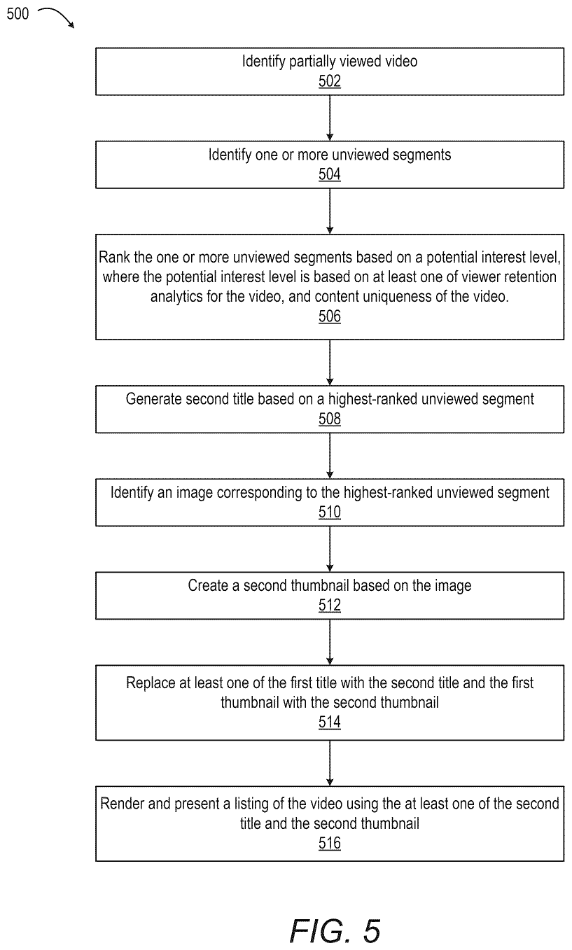

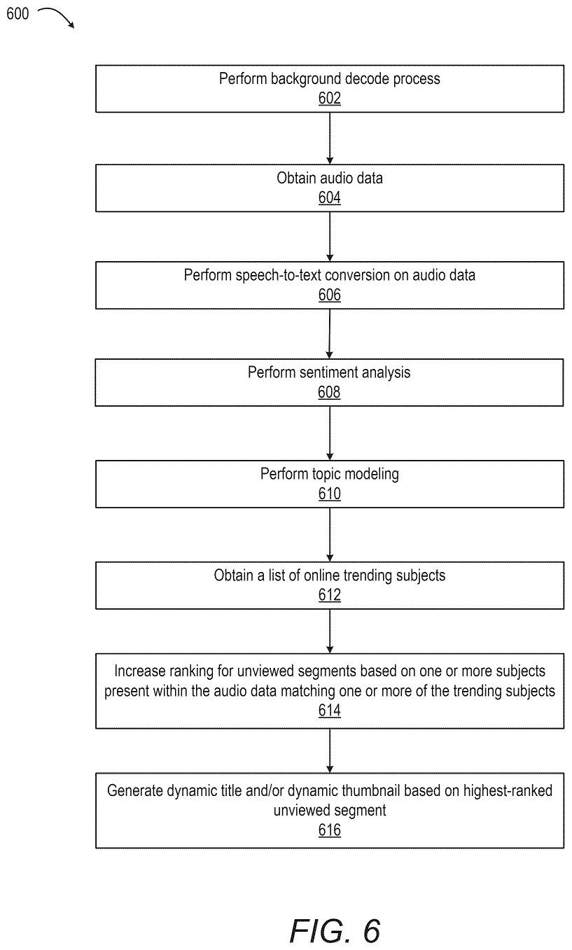

Referring now to the flowcharts presented by FIG. 5 and FIG. 6, the descriptions of the methods in FIG. 5 and FIG. 6 are provided with general reference to the specific components and features illustrated within the preceding FIGS. 1-4. Specific components referenced in the methods of FIG. 5 and FIG. 6 may be identical or similar to components of the same name used in describing preceding FIGS. 1-4. In one or more embodiments, processor 112 (FIG. 1A) configures electronic device 100 (FIG. 1A) to provide the described functionality of the methods of FIG. 5 and FIG. 6 by executing program code for one or more modules or applications provided within system memory 120 of electronic device 100, including dynamic thumbnail modification (DTM) module 125.

FIG. 5 depicts a flowchart of a computer-implemented method for dynamic thumbnail and/or title modification for a partially viewed video on an electronic device, according to one or more embodiments. The method 500 starts at block 502, where a partially viewed video is identified. In one or more embodiments, a position where the video was stopped is saved in a cache on the electronic device, enabling the resume point for the video to be identified when the video reappears in a video listing. The method 500 continues to block 504, where one or more unviewed segments are identified. In embodiments, the unviewed segments can be based on metadata for the video that identifies segments, subsections, and/or chapters of the video, such as depicted in representation 300 of FIG. 3. The method 500 continues to block 506, where one or more unviewed segments of a video asset are ranked, based on a potential interest level, where the potential interest level is based on at least one of viewer retention analytics for the video and/or content uniqueness of the video. In one or more embodiments, a machine learning (ML)-powered ranking system can be used to analyze unviewed segments of a video asset and rank them based on a potential interest level for a specific user. This ranking can leverage a combination of viewer retention analytics and content uniqueness to determine which segments are most likely to engage the viewer. A supervised and/or semi-supervised ML model can be trained using historical viewing data, where labeled training samples can include segments with high and low retention rates across multiple users. Features used for training can include average watch duration, drop-off points, user rewatches, and/or engagement metrics (likes, comments, shares). By analyzing these patterns, the model can predict which parts of a video are more engaging and can assign an interest score to each unviewed section.

To further refine ranking, one or more embodiments can incorporate content uniqueness detection identification using natural language processing (NLP) and/or computer vision models. The NLP techniques can be used to analyze transcripts and/or subtitles to identify topics that are novel within the video. Similarly, computer vision models can be used to detect unique visual elements (e.g., a new scene, a different speaker, and/or a shift in sentiment). One or more embodiments may further utilize reinforcement learning, in which the model adapts over time based on real-time user interactions, adjusting rankings based on how often users choose to watch suggested segments. The final output can include a personalized video listing with dynamically generated titles and/or thumbnails and/or mini descriptions that can promote user engagement and improve completion rates, benefiting both viewers and content creators.

The method 500 continues to block 508, where a second title is generated (e.g., using NLP techniques), based on a highest-ranked unviewed segment. The method 500 continues to block 510, where a second thumbnail image is created (e.g., using computer vision and/or other image processing techniques), based on a highest-ranked unviewed segment. The method 500 continues to block 512, where a second thumbnail is created based on the image. In some embodiments, the second thumbnail can be a scaled version of the image. In some embodiments, the second thumbnail can be an augmented image, based on the image. In some embodiments, the second thumbnail can be generated or retrieved from an image source based on the content contained within the highest-ranked unviewed segment or a next unviewed segment determined to be of interest to the particular user. In some embodiments, the augmented image can be reversed, color shifted, stretched, and/or other type of augmentation. In some embodiments, a computer-generated image, such as from a GAN, may be used as the second thumbnail. The method 500 continues to block 514 where the first title is replaced with a second title and/or a first thumbnail is replaced with a second thumbnail. The method 500 then continues to block 516, where a listing of the video within a video listing is rendered using the at least one of the second title and/or the second thumbnail and presented on a display of an electronic device, such as depicted in FIGS. 2B-2D.

FIG. 6 depicts a flowchart of a computer-implemented method for analyzing content in order to implement dynamic thumbnail and/or title modification of a partially viewed video on an electronic device, according to one or more embodiments. The method 600 starts at block 602, where a background decode process is performed. The background decode process of disclosed embodiments can provide multiple advantages, including enhanced content organization, improved user engagement, and more dynamic video listing presentation. The background decode process can include preemptively decoding video data in the background without rendering it on the display, allowing extraction of structural and semantic insights before the user even interacts with the video. By leveraging idle processing time and available system resources, the electronic device can analyze video frames, detect topics, chapters, and/or sections, and generate metadata that enhances the user's experience when viewing the video listing. The described features can enable the platform to dynamically update thumbnails and titles for partially viewed videos, ensuring that users receive the most relevant and engaging previews based on the users' viewing history and interests.

The method 600 continues to block 604, where audio data from the video asset is obtained. In one or more embodiments, the feature can include a lightweight video processing pipeline that operates within system constraints to avoid excessive battery and resource usage. The method 600 continues to block 606 where speech-to-text conversion on the audio data is performed to generate an audio transcript. The pipeline may utilize machine learning-based scene detection and/or natural language processing (NLP) on subtitles and/or audio transcripts based on the audio data, to identify key moments and topics. Additionally, in one or more embodiments, computer vision techniques can be used to analyze frames to determine contextually significant imagery for thumbnail selection. One or more embodiments may prioritize videos for background decoding based on factors such as user watch history, trending content, and/or platform recommendations. Once processed, the extracted metadata can be stored locally, ensuring that dynamic thumbnails and personalized titles are available when the video appears in the listing. This approach can enhance content discoverability while optimizing system performance, potentially driving higher engagement and completion rates. In one or more embodiments, the pipeline can include a GStreamer pipeline that is configured to decode video data without rendering the video to the screen by directing the output to a null sink. This approach allows the system to analyze video frames, extract key metadata (e.g., chapter boundaries, scene changes, and detected objects), and discard the video frames after processing, thereby reducing resource consumption

In one or more embodiments, the speech-to-text conversion on the audio data can include performing automated speech recognition (ASR), which can involve transcribing spoken language into text using models trained on large datasets. The models can include statistical methods such as Hidden Markov Models (HMMs) or more advanced neural network architectures such as Deep Neural Networks (DNNs) and Long Short-Term Memory networks (LSTMs). In one or more embodiments, the ASR can be enhanced with acoustic and/or linguistic models to improve accuracy.

The method 600 continues to block 608 where sentiment analysis is performed. The method 600 then continues to block 610 where topic modeling is performed. To determine a video's sentiment, topic, and/or organizational structure, embodiments can apply Natural Language Processing (NLP) techniques such as topic modeling and/or sentiment analysis to the transcribed text. In one or more embodiments, the background decode process is non-real-time. Thus, the decoding can be performed faster or slower than normal playback. Additionally, for local analysis on the electronic device, idle time can be exploited to perform the speech-to-text processing locally, without needing to use network resources and/or adversely impacting the user experience due to performance factors.

In one or more embodiments, the sentiment analysis can include identifying the emotional tone within the text by classifying the tone into categories such as positive, negative, or neutral. This can be achieved using machine learning algorithms, such as Naive Bayes, support vector machines (SVMs), and/or deep learning models like convolutional neural networks (CNNs) and recurrent neural networks (RNNs). In embodiments, pre-trained models such as BERT (Bidirectional Encoder Representations from Transformers) can be used to enhance accuracy in sentiment analysis by understanding context and nuances in language. One or more embodiments can include: performing a background decoding process to obtain audio data corresponding to each of the one or more unviewed segments; performing speech-to-text conversion on the audio data to generate a text transcript of the audio data; and performing a sentiment analysis on the text transcript to identify audio data corresponding to one or more emotions of interest.

In one or more embodiments, the topic modeling can be performed using unsupervised learning techniques such as Latent Dirichlet Allocation (LDA) and/or Non-Negative Matrix Factorization (NMF), which can analyze the text to find patterns in word co-occurrence and group related words into topics. Additionally, advanced NLP techniques, such as word embeddings (e.g., Word2Vec, GloVe) and Transformer-based models, can be utilized to improve topic modeling by capturing semantic relationships between words.

The method 600 continues to block 612, where a list of online trending subjects is obtained. In one or more embodiments, obtaining the list can include making use of a search engine API, such as the Google Trends API, and/or the Bing News Search API. These APIs can return the data in a JSON format for identification of the trending subjects. The method 600 then continues to block 614, where the ranking for unviewed segments is increased based on the topic of the segments matching or correlating to one or more of the trending subjects. One or more embodiments can include: performing a topic modeling process on the text transcript to determine one or more subjects present within the audio data; obtaining a list of online trending subjects; and increasing a ranking for the one or more unviewed segments based on one or more subjects present within the audio data matching one or more of the trending subjects. In some embodiments, the fetching of the latest trending topics is performed on a regular interval (e.g., hourly) to ensure the data is up-to-date. The method 600 continues to block 616, where a dynamic title and/or dynamic thumbnail are generated based on the highest-ranked unviewed segment.

One or more embodiments may utilize NLP techniques to process video transcripts and extract discussed topics. The processing of the videos can involve using ASR to transcribe the audio, followed by topic modeling techniques such as LDA to identify key topics within the video. Embodiments may further include comparing extracted video topics with trending topics. If there is a match or high correlation between an unwatched video segment and a trending topic, a higher-ranking score can be assigned to that segment/section of the video. The ranking score can be used for selection of the unviewed section that is best-suited as a basis to dynamically create a new/modified/updated title and/or thumbnail for use with a partially viewed video. One or more embodiments can further utilize user feedback loops to refine the matching algorithm and ranking criteria over time based on user engagement and feedback.

The flowcharts, sequences, and configurations presented herein are provided solely for illustrative purposes and are exemplary in nature. These embodiments are not intended to be limiting and may include variations with more, fewer, and/or alternative options, sequences, or features as would be apparent to those skilled in the art.

As can now be appreciated, disclosed embodiments provide techniques that enable partially viewed videos in a user's listing to have dynamically changing titles and/or video thumbnails, which can benefit both viewers and content creators. For viewers, disclosed embodiments can provide subtle yet effective reminders to continue watching content they previously enjoyed but might have forgotten about. Dynamic titles and thumbnails can capture the user's attention by highlighting key moments or unresolved plot points, sparking the user's curiosity to see what happens next. For content creators, disclosed embodiments can result in higher viewer retention rates, as viewers are more likely to resume and finish watching their videos. The dynamic thumbnails and titles not only can boost the video's overall watch time but also may increase engagement metrics, which can lead to improved visibility and recommendations within the platform. Thus, disclosed embodiments can enable a more engaging and interactive experience, benefiting both viewers and content creators by ensuring content is revisited and enjoyed to its fullest extent.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

1. An electronic device comprising:
at least one display;
a memory; and
at least one processor communicatively coupled to the at least one display and the memory, the at least one processor is configured to cause the electronic device to:
identify that a video is a partially viewed video that a user has stopped watching prior to reaching an end of the video, wherein the video is represented within a video listing user interface by a first listing having a corresponding first title and first thumbnail, wherein the video listing user interface provides a list of video assets that are available to view, each video asset being a different video available for viewing with an associated title;
identify one or more unviewed segments of the video;
rank the one or more unviewed segments based on a potential interest level, wherein the potential interest level is based on at least one of viewer retention analytics for the video and content uniqueness of the video;
generate a second title based on a highest-ranked unviewed segment from the one or more unviewed segments;
identify an image from within the one or more unviewed segments corresponding to the highest-ranked unviewed segment;
create a second thumbnail based on the image;
replace at least one of the first title with the second title and the first thumbnail with the second thumbnail; and
render and present, on the at least one display, an updated listing of the video within the video listing user interface, the updated listing presenting at least one of the second title and the second thumbnail in place of a corresponding one of the first title and the first thumbnail.

2. The electronic device of claim 1, wherein to rank the one or more unviewed segments based on a potential interest level, the at least one processor is further configured to cause the electronic device to:
perform a background decoding process to obtain audio data corresponding to each of the one or more unviewed segments;
perform speech-to-text conversion on the audio data to generate a text transcript of the audio data; and
perform a sentiment analysis on the text transcript to identify audio data corresponding to one or more emotions of interest.

3. The electronic device of claim 2, wherein to rank the one or more unviewed segments based on a potential interest level, the at least one processor is further configured to cause the electronic device to:
perform a topic modeling process on the text transcript to determine one or more subjects present within the audio data;
obtain a list of online trending subjects; and
increase a ranking for the one or more unviewed segments based on one or more subjects present within the audio data matching one or more of the trending subjects.

4. The electronic device of claim 1, wherein to create a second video thumbnail based on the image, the at least one processor is further configured to cause the electronic device to:
generate a mini description of the second title;
create a text string of the mini description; and
composite the text string on the image, wherein the text string is superimposed on the image.

5. The electronic device of claim 4, wherein to generate the mini description of the second title, the at least one processor is further configured to cause the electronic device to use a natural language processing (NLP) process to generate the mini description of the second title.

6. The electronic device of claim 1, wherein further, the at least one processor is configured to cause the electronic device to:
obtain data for a user associated with the electronic device; and
use the data as a criterion to rank the one or more unviewed segments based on a potential interest level of the user.

7. The electronic device of claim 6, wherein to obtain data for the user, the at least one processor is further configured to:
obtain demographics data; and
identify one or more interests corresponding to the user.

8. The electronic device of claim 1, wherein further, the at least one processor is configured to cause the electronic device to render and present, on the at least one display of the electronic device, a notification indicating a replaced at least one of the title and the thumbnail for the video.

9. A method comprising:
identifying, by at least one processor of an electronic device that includes at least one display, a video that is a partially viewed video that a user has stopped watching prior to reaching an end of the video, wherein the video is represented within a video listing user interface by a first listing having a corresponding first title and first thumbnail, wherein the video listing user interface provides a list of video assets that are available to view, each video asset being a different video available for viewing with an associated title;
identifying one or more unviewed segments of the video;
ranking the one or more unviewed segments based on a potential interest level, wherein the potential interest level is based on at least one of viewer retention analytics for the video and content uniqueness of the video;
generating a second title based on a highest-ranked unviewed segment from the one or more unviewed segments;
identifying an image from within the one or more unviewed segments corresponding to the highest-ranked unviewed segment;
creating a second thumbnail based on the image;
replacing at least one of the first title with the second title and the first thumbnail with the second thumbnail; and
rendering and presenting, on the at least one display, an updated listing of the video within the video listing user interface, the updated listing presenting at least one of the second title and the second thumbnail in place of a corresponding one of the first title and the first thumbnail.

10. The method of claim 9, further comprising:
performing a background decoding process to obtain audio data corresponding to each of the one or more unviewed segments;
performing speech-to-text conversion on the audio data to generate a text transcript of the audio data; and
performing a sentiment analysis on the text transcript to identify audio data corresponding to one or more emotions of interest.

11. The method of claim 10, further comprising:
performing a topic modeling process on the text transcript to determine one or more subjects present within the audio data;
obtaining a list of online trending subjects; and
increasing a ranking for the one or more unviewed segments based on one or more subjects present within the audio data matching one or more of the trending subjects.

12. The method of claim 9, further comprising:
generating a mini description of the second title;
creating a text string of the mini description; and
compositing the text string on the image, wherein the text string is superimposed on the image.

13. The method of claim 12, wherein generating the mini description of the second title comprises using a natural language processing (NLP) process to generate the mini description of the second title.

14. The method of claim 9, further comprising:
obtaining data for a user associated with the electronic device; and
using the data as a criterion to rank the one or more unviewed segments based on a potential interest level of the user.

15. The method of claim 14, further comprising:
obtaining demographics data; and
identifying one or more interests corresponding to the user.

16. The method of claim 9, further comprising rendering and presenting, on the at least one display of the electronic device, a notification indicating a replaced at least one of the title and the thumbnail for the video.

17. A computer program product comprising a non-transitory computer readable medium having program instructions that when executed by a processor of an electronic device comprising at least one display, configure the electronic device to perform functions comprising:
identifying a video that is a partially viewed video that a user has stopped watching prior to reaching an end of the video, wherein the video is represented within a video listing user interface by a first listing having a corresponding first title and first thumbnail, wherein the video listing user interface provides a list of video assets that are available to view, each video asset being a different video available for viewing with an associated title;
identifying one or more unviewed segments of the video;
ranking the one or more unviewed segments based on a potential interest level, wherein the potential interest level is based on at least one of viewer retention analytics for the video and content uniqueness of the video;
generating a second title based on a highest-ranked unviewed segment from the one or more unviewed segments;
identifying an image from within the one or more unviewed segments corresponding to the highest-ranked unviewed segment;
creating a second thumbnail based on the image;
replacing at least one of the first title with the second title and the first thumbnail with the second thumbnail; and
rendering and presenting, on the at least one display, an updated listing of the video within the video listing user interface, the updated listing presenting at least one of the second title and the second thumbnail in place of a corresponding one of the first title and the first thumbnail.

18. The computer program product of claim 17, further comprising program instructions for performing functions comprising:
performing a background decoding process to obtain audio data corresponding to each of the one or more unviewed segments;
performing speech-to-text conversion on the audio data to generate a text transcript of the audio data; and
performing a sentiment analysis on the text transcript to identify audio data corresponding to one or more emotions of interest.

19. The computer program product of claim 18, further comprising program instructions for performing functions comprising:
performing a topic modeling process on the text transcript to determine one or more subjects present within the audio data;
obtaining a list of online trending subjects; and
increasing a ranking for the one or more unviewed segments based on one or more subjects present within the audio data matching one or more of the trending subjects.

20. The computer program product of claim 17, further comprising program instructions for performing functions comprising:
generating a mini description of the second title;
creating a text string of the mini description; and
compositing the text string on the image, wherein the text string is superimposed on the image.
